(19) United States
(12) Patent Application Publication
(10) Pub. No.: US 2015/0226002 A1
(43) Pub. Date: Aug. 13, 2015

(54) Fixed Ladder Portable Mounted Support Assembly

(71) Applicant: Dale Lee Johansen, Meridian, ID (US)

(72) Inventor: Dale Lee Johansen, Meridian, ID (US)

(21) Appl. No.: 14/176,116

(22) Filed: Feb. 9, 2014

(51) Int. Cl. E06C 7/10

(52) U.S. Cl. CPC E06C 7/10

(57) ABSTRACT

The invention provides an adjustable ladder mounted system to facilitate the use of a lifting or support apparatus. This steel clamping system distributes the weight to four (4) different locations of a permanently mounted fixed ladder. The clamping system adjusts for all common ladder rail/leg sizes, and differences in spacing of the ladder rungs. This design allows for ease of set-up and use by a single worker, results in a solidly supported lifting structure/pole/shaft, economically produced, and can be easily moved from one location to another.

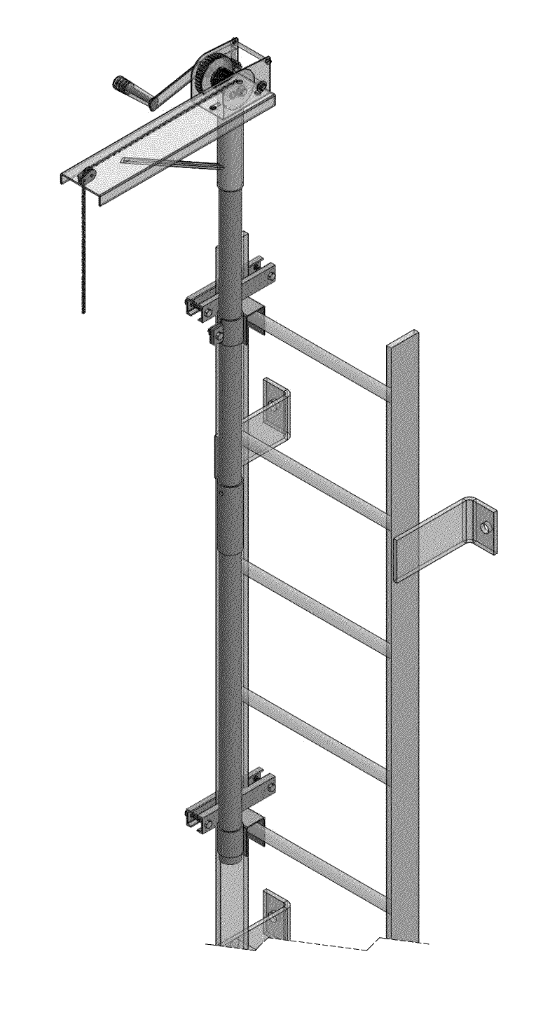

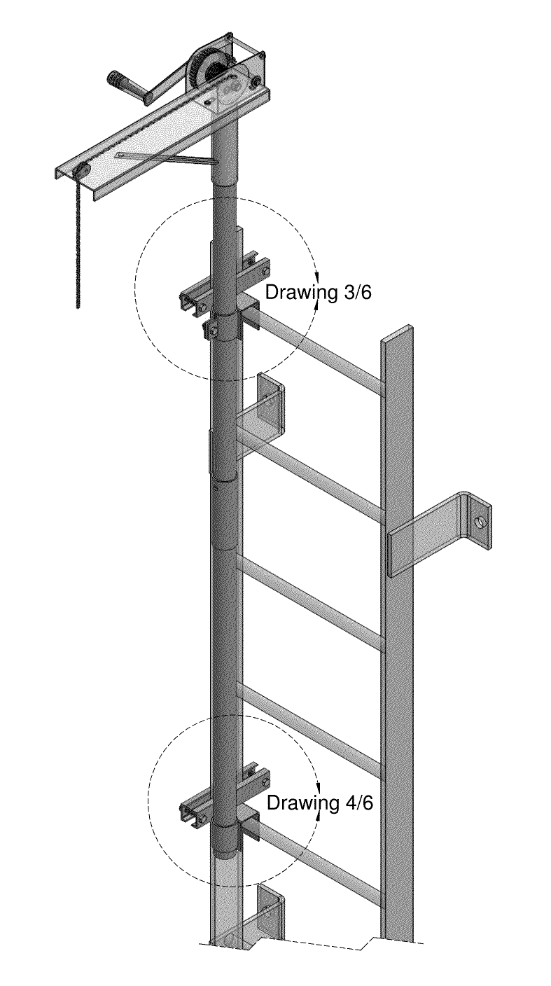

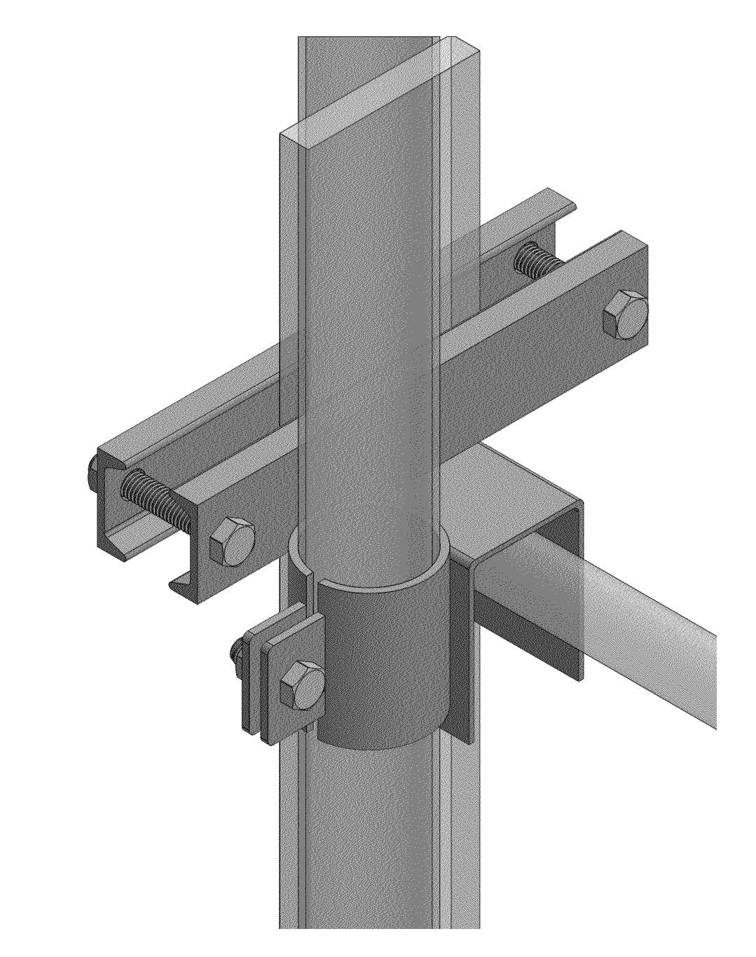

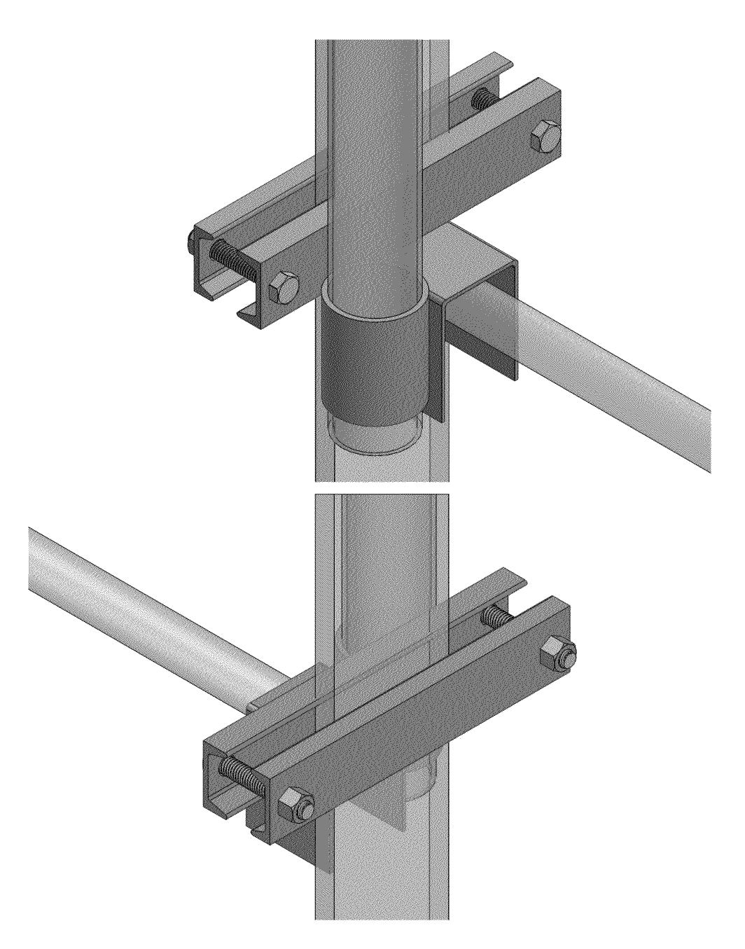

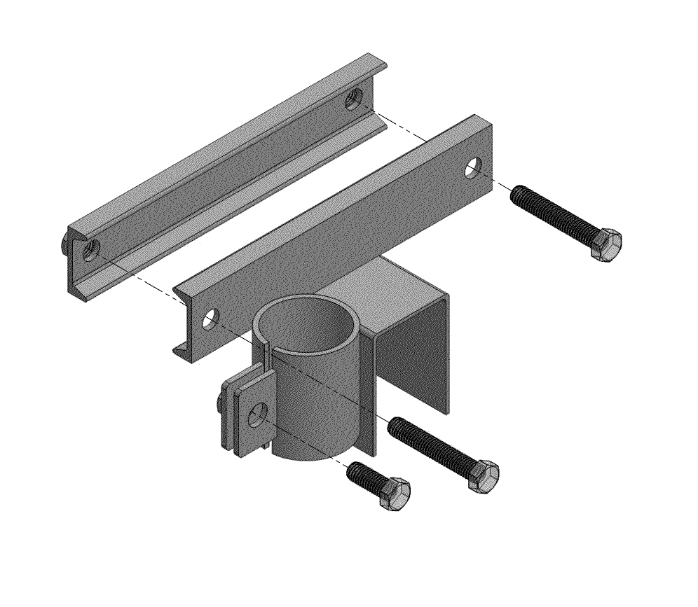

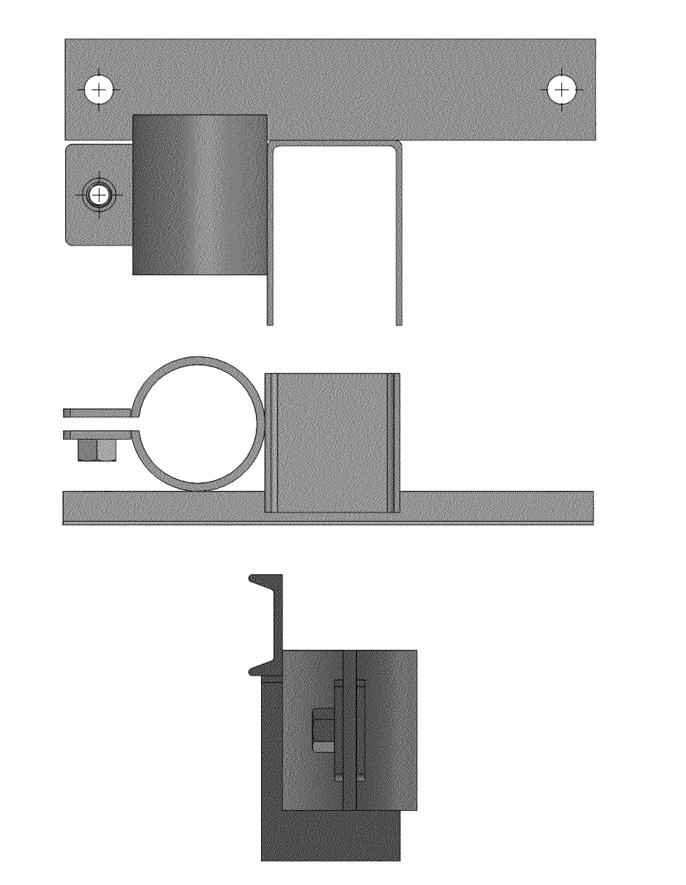

### CROSS-REFERENCE TO RELATED APPLICATIONS

Not Applicable

### BACKGROUND OF THE INVENTION

The present invention is generally related to the support and lift arts of Class 248 and, in particular, to the use of an existing ladder, and method of use.

For many service and repair usages, an existing and permanent ladder is readily available.

An extensive search of U.S. companies revealed only one ladder mounted support system was available to the general public. This assembly was not adjustable for different ladder rail dimensions, and would only mount to about 60% of existing ladders. This system also had no clamping apparatus to solidly secure their system to the ladder rail.

Accordingly, it is an object of the present invention to set forth a novel ladder lift and support system which enables ease of set-up and use by a single workman.

It is a further object to show a system and method of ladder usage which enhances safety for a workman without costly manufacturing processes and expenses.

These and other objects and advantages of the present invention will be apparent to those of skill in the support and ladder lift arts from the description which follows.

### SUMMARY

A pair of specially designed clamp structures which are utilized and positioned on two ladder lift rungs, and clamped to the side ladder rail, of a fixed permanently mounted ladder. The bottom steel clamp assembly is welded to the lifting pole/shaft for strength and ease of use. The top steel bracket, which mounts the same, is adjustable up/down to the upper ladder rung, for ladder manufacturer distance discrepancies. Each clamp assembly contains a “U” shaped channel which is supported by a ladder rung, and also an adjustable clamp which attaches to the ladder rail/leg. This clamping arrangement results in the weight of the support pole/shaft, any lifting apparatus/hoist/crane, and any load, to be distributed across 4 different areas of the ladder.

The overall system provides for maximum flexibility in use of a permanently mounted ladder at a work site. Increased convenience since the invention consisting of the pole/shaft and clamps can be easily relocated for use at different locations.

Enhanced safety for a workman since the design provides for a more solid securing of a lifting apparatus.

This adjustable clamping system will install on 146 of all ladders tested in our research of 147 commercial locations with fixed ladders.

### PRIOR ART PATENTS AND DESIGNS

During the course of preparing this specification for submission to the U.S. Patent Office, a full search of the prior art was conducted.

U.S. Pat. No. 408,608 is at least broadly related to the present invention since they teach a means of lifting items to the roof, however not utilizing an existing ladder.

U.S. Pat. No. 4,995,578 uses a ladder, and bracket assembly to utilize their Apparatus, but is not designed to lift anything. and would support minimum weight.

U.S. Pat No. 6,459,049 uses a ladder in conjunction with a ladder lift, however this system only works with a portable unattached ladder.

U.S. Pat. No. 4,025,016 utilizes a clamp system for use with a ladder, but will not support a pole or shaft for lifting purposes.

The present invention is submitted to clearly define over the prior art systems and methods of use as they relate to ladders.

### DESCRIPTION OF THE SEVERAL VIEWS OF THE DRAWING

DRAWING 1/6 is a view of the major components used in the claimed combination, utilizing a ladder and lifting apparatus.

DRAWING 2/6 is a view of the major components used in the claimed combination, identifying the two unique brackets illustrated in Drawings 3/6 and 4/6.

DRAWING 3/6 is a view of the welded upper bracket assembly, which adjusts up/down the shaft/pole. Once in place, three bolts are tightened to secure the pole to the bracket, and the bracket to the ladder rail.

DRAWING 4/6 are 2 views of the lower bracket/pole assembly, in which the bracket is permanently welded to the pole, and clamps to the ladder rail. When in use, this bracket also has a “U” shaped channel which loop's over the ladder rung, to disperse additional weight.

DRAWING 5/6 shows only the upper adjustable bracket as a welded assembly, and illustrates the bolting pattern which secures it to the pole and ladder rail. When in use, this bracket also has a “U” shaped channel which loop's over the ladder rung, to disperse additional weight.

DRAWING 6/6 illustrates 3 views of the upper bracket, which is one solid welded piece.

### DETAILED DESCRIPTION OF THE INVENTION

The invention is made from common steel, available from metal distributors. The bottom bracket is welded together and also welded to the bottom of the pole/shaft for ease of installation. The top bracket is a welded assembly, and slides on the shaft so it can adjust to different spacing of ladder rungs. Each bracket hangs on a ladder rung, to assist in the installation, and to distribute some weight to the rung. Each bracket clamps to the side ladder rail, which adds a lot of stability, and distributes weight to the rail. The top bracket is then tightened to the pole/shaft. This pole/shaft assembly can be used for multiple applications, including supporting a crane/hoist for lifting material and items. To maximize the flexibility of ladders this system can be installed on, both rail brackets are adjustable, and the top bracket adjusts to the ladder rung spacing. We plan to supply this assembly as a kit, completely assembled, and with a powder coated finish for durability.

1. A support shaft/pole intended to be temporarily attached to an existing fixed ladder, consisting of a pair of specially designed clamp structures which are utilized and positioned on two ladder lift rungs, and clamped to the side ladder rail, with the top steel bracket being adjustable up/down to the upper ladder rung for ladder manufacturer distance discrepancies, which results in the weight of the support pole/shaft and any lifting apparatus/hoist/crane, along with any load, to be distributed across 4 different areas of the ladder, resulting in a solid, secure, portable, and safe application.
